(19) United States
(12) Patent Application Publication
(10) Pub. No.: US 2013/0236233 A1
(43) Pub. Date: Sep. 12, 2013

(54) RING MECHANISM HAVING ROBUST LOW-PROFILE HOUSING

(71) Applicant: WORLD WIDE STATIONERY MFG. CO., LTD., Hong Kong (CN)

(72) Inventor: Zhu Gui LUI, Yue Yang City (CN)

(73) Assignee: World Wide Stationery Mfg. Co., Ltd., Hong Kong (CN)

(21) Appl. No.: 13/866,594

(22) Filed: Apr. 19, 2013

Related U.S. Application Data
(63) Continuation of application No. 13/606,209, filed on Sep. 7, 2012, now abandoned.

(30) Foreign Application Priority Data
Sep. 7, 2011 (CN) 201110263680.2
Sep. 7, 2011 (CN) 201120335071.9

(51) Int. Cl. B42F 13/22

(52) U.S. Cl. CPC B42F 13/22
USPC 402/36

(57) ABSTRACT

A ring mechanism for holding loose-leaf pages has an elongate housing having a central portion and longitudinally extending sides on opposite sides of the central portion. Hinge plates are supported by the housing for pivoting movement. Rings for holding the loose-leaf pages, each include a first ring member and a second ring member. The first ring member is mounted on and moveable with one of the hinge plates relative to the second ring member between a closed position and an open position. The housing has an opening extending laterally inward toward a center of the housing for receiving one of the first ring members. The housing has a vault-forming portion at the inner margin of the opening. The vault-forming portion of the housing is spaced from a longitudinal centerline of the housing and raised above longitudinally adjacent portions of the housing spaced the same distance from the centerline.

### CROSS REFERENCE TO RELATED APPLICATION

This application is a continuation of U.S. application Ser. No. 13/606,209, filed Sep. 7, 2012, which claims priority to Chinese Application Nos. 201110263680.2 and 201120335071.9, both of which were filed Sep. 7, 2011, the entire contents of which are all hereby incorporated by reference.

### FIELD OF INVENTION

The present invention relates generally to ring binder mechanisms for holding loose-leaf pages and more particularly to ring binder mechanisms in which ring members are mounted on pivoting hinge plates that are supported by a metal housing having openings in its side for receiving the ring members.

### BACKGROUND

Various ring mechanisms for retaining loose-leaf pages are known in the art. One type of prior art ring mechanism includes a plurality of rings made of paired ring members mounted on pivoting hinge plates (which are sometimes referred to as carrier rails, ring supports, or toggle plates). A metal housing has bent under rims extending along its opposite longitudinally extending sides. The hinge plates are arranged side-by-side with one another and extend longitudinally in the housing. The outer side edge of each hinge plate is received in a channel formed by the bent under rims at the side of the housing. The ring members extend from the hinge plates though openings in the housing (e.g., notches extending in from the sides of the housing) so the ring members together form a continuous loop extending above the housing when the rings are closed. The hinge plates are typically dimensioned so the combined width of the hinge plates is greater than the distance between the channels on opposite sides of the housing when the housing is in its un-deformed configuration. The hinge plates pivot through a co-planar position as the rings move between open and closed positions. Consequently, opening or closing the rings requires the housing to be deformed to spread the sides of the housing far enough apart to accommodate the combined width of the hinge plates in their co-planar position. This arrangement of features results in the metal housing providing a toggling spring force that tends to hold the rings in the closed position when the rings are closed and tends to hold the rings in the open position when the rings are open. An example of this type of prior art ring mechanism is described in U.S. Pat. No. 4,552,478.

The housings of the ring mechanisms described above are suitably manufactured by forming the housings out of sheet metal. It is desirable to minimize cost by making the housing from sheet metal having the minimum thickness that will still provide the necessary strength. It is also desirable to make the housing so the central portion of the housing between the sides is relatively low to reduce the profile of the ring mechanism. The housing occupies some of the space that could be occupied by loose-leaf pages. Thus, all other things being equal, a ring mechanism having a lower profile housing has the capacity to hold more loose-leaf pages than a ring mechanism having a higher profile housing.

However, there are other design constraints that limit the thinness of the housing and/or the extent to which the profile can be lowered. One of these constraints is that the housing has to be strong enough to withstand forces exerted on it by the hinge plates and other objects during operation of the ring mechanism. Another is that the housing has to be strong enough to withstand forces exerted on it during assembly of the ring mechanism. Moreover, it is sometimes desirable to use automated machines to assemble the ring mechanisms. At least some types of machines used to assemble ring mechanisms require the openings in the housing for receiving the ring members to be notches that extend all the way to the edge of the housing so the ring members can be inserted transversely into their respective opening from the side of the opening. However, this results in a relatively weak narrow neck in the housing where the central portion of the housing extends between the openings for a pair of ring members on opposite sides of the housing. This narrow neck portion is one of the weakest points of the housing and makes the housing vulnerable to being bent, particularly during manufacture of the ring mechanism before the housing is reinforced by the relatively stiff hinge plates.

Housings made from thicker metal and/or shaped to have a relatively higher profile can be more robust because of the increased strength associated with thicker metal and/or the increased bending moment resulting from the cross sectional shape and/or wider neck between the openings for the ring members that can be achieved using a higher profile housing. The housing would be stronger if the openings for the rings did not extend all the way to the sides of the housing, but this requires the ends of the ring members to be inserted through the opening. This is a more complex assembly step and at least some of the machines that are suitable for use when the openings are notches that extend all the way to the side of the housing cannot be used when the openings do not extend all the way to the side of the housing. Typically, assembly of ring mechanisms in which the openings do not extend all the way to the sides of the housing is done manually rather than with automated machines. Thus, there are additional costs associated with the more complex assembly when the openings for the ring members do not extend all the way to the sides of the housing.

### SUMMARY

One aspect of the invention is a ring mechanism for holding loose-leaf pages. The mechanism includes an elongate housing having a central portion and longitudinally extending sides on opposite sides of the central portion. First and second hinge plates are supported by the housing for pivoting movement relative to the housing. The mechanism has rings for holding the loose-leaf pages. Each ring includes a first ring member and a second ring member. The first ring member is mounted on the first hinge plate and moveable with the pivoting motion of the first hinge plate relative to the second ring member between a closed position and an open position. The first and second ring members form a substantially continuous closed loop in the closed position. The first and second ring members form a discontinuous open loop in the open position. The housing has an opening for receiving one of the first ring members. The opening extends laterally inward toward a longitudinal centerline of the elongate housing. The housing has a vault-forming portion at the inner margin of the opening. The vault-forming portion of the housing is spaced from a longitudinal centerline of the housing and raised above longitudinally adjacent portions of the housing spaced the same distance from the centerline.

Another aspect of the invention is a ring mechanism for holding loose-leaf pages. The ring mechanism includes an elongate housing having a central portion and longitudinally extending sides on opposite sides of the central portion. First and second hinge plates are supported by the housing for pivoting movement relative to the housing. The mechanism has rings for holding the loose-leaf pages. Each ring includes a first ring member and a second ring member. The first ring member is mounted on the first hinge plate and moveable with the pivoting motion of the first hinge plate relative to the second ring member between a closed position and an open position. The first and second ring members form a substantially continuous closed loop in the closed position. The first and second ring members form a discontinuous open loop in the open position. The housing has an opening for receiving one of the first ring members. The opening extends laterally toward a longitudinal centerline of the elongate housing. The housing having an upturned lip at the inner margin of the opening.

Another aspect of the invention is a ring mechanism for holding loose-leaf pages. The ring mechanism includes an elongate housing having a central portion and longitudinally extending sides on opposite sides of the central portion. First and second hinge plates are supported by the housing for pivoting movement relative to the housing. The mechanism has rings for holding the loose-leaf pages. Each ring includes a first ring member and a second ring member. The first ring member is mounted on the first hinge plate and moveable with the pivoting motion of the first hinge plate relative to the second ring member between a closed position and an open position. The first and second ring members form a substantially continuous closed loop in the closed position. The first and second ring members form a discontinuous open loop in the open position. The housing has an opening for receiving one of the first ring members. The opening extends laterally toward a longitudinal centerline of the elongate housing. The housing has a raised bump at the inner margin of the housing. The bump is configured to extend over a segment of said one of the first ring members when the rings are in the closed position. The housing further comprising a dimple positioned along the longitudinal centerline of the housing and extending downward toward the hinge plates to protect the housing from being damaged by the hinge plates as the rings move into the open position. The dimple is offset axially on the housing the ring members.

Other objects and features will in part be apparent and in part pointed out hereinafter.

### BRIEF DESCRIPTION OF THE DRAWINGS

FIG. 1 is a perspective of one embodiment of a ring mechanism mounted on a notebook cover;

FIG. 2 is a top plan view of the ring mechanism illustrated in FIG. 1;

FIG. 3 is a bottom plan view of the ring mechanism illustrated in FIG. 1;

FIG. 4 is an exploded perspective of the ring mechanism illustrated in FIG. 1,

FIG. 5 is a perspective of the ring mechanism illustrated in FIG. 1 sectioned on a plane including line 5-5 on FIG. 2 to show internal features;

FIG. 6 is a perspective similar to FIG. 5 but showing the rings in their open position;

FIG. 7 is an enlarged perspective of a portion of the ring mechanism illustrated in FIG. 1 showing an opening in the housing of the ring mechanism for one of the ring members;

FIG. 8 is an enlarged perspective of the ring mechanism illustrated in FIG. 1 similar to FIG. 7 but with the ring member in an open position;

FIG. 9 is a cross section of the ring mechanism illustrated in FIG. 1 taken in a plane including line 9-9 on FIG. 2;

FIG. 10 is an enlarged side view of a portion of the housing of the ring mechanism illustrated in FIG. 1 showing one of the openings in the housing for a ring member; and

FIG. 11 is an enlarged perspective of another embodiment of a ring mechanism having an opening for a ring member that does not extend all the way to the side of the housing of the ring mechanism.

Corresponding reference numbers indicate corresponding parts throughout the drawings.

### DETAILED DESCRIPTION

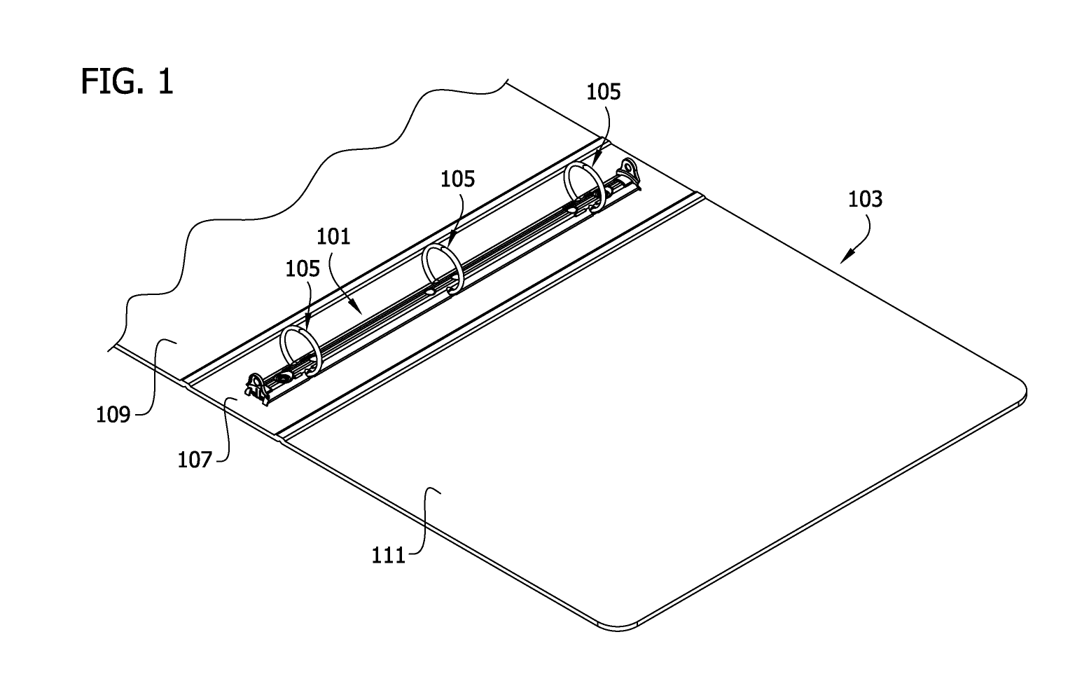

Referring to the drawings, FIGS. 1-10 illustrate one embodiment of a ring mechanism, generally designated 101, that is suitable for holding loose-leaf pages (not shown). As illustrated, the mechanism 101 is mounted on a cover 103 (e.g., a notebook cover) adapted to selectively cover or expose any loose-leaf pages retained on the rings 105. For example, the cover 103 in FIG. 1 includes a spine 107 and front and back cover portions 109, 111 hingedly attached to opposite sides of the spine. The ring mechanism 101 can be mounted in various positions on the cover 103. For example, it is common to mount ring mechanisms on the spine or on one of the cover portions adjacent the spine, although it is possible to mount the ring mechanism elsewhere within the scope of the invention. In FIG. 1, the mechanism 101 is mounted on the spine 107 of the cover 103. The ring mechanism 101 can also be mounted on different kinds of covers or substrates within the scope of the invention. For instance, the cover may be a flexible sheet that operates similarly to the cover illustrated in FIG. 1 except that the flexing between the spine and cover portions is spread out over a larger area or over multiple pseudo hinge lines such that the movement between the spine and the cover portions is not constrained to a single well-defined pivot axis. Similarly, the ring mechanism 101 can be mounted on other objects, such as clip boards, brief cases, etc. within the scope of the invention.

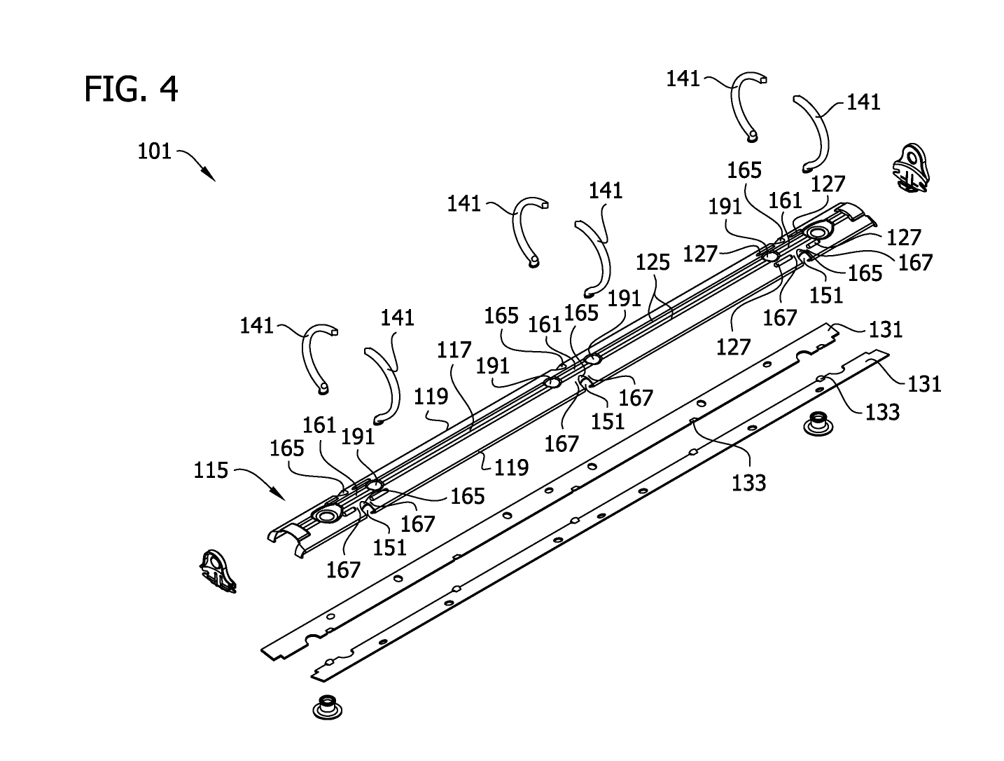

The mechanism 101 includes an elongate housing 115 (FIG. 4). The housing 115 is suitably formed by stamping a piece of flat sheet metal. The type of metal used to make the housing 115 can vary within the scope of the invention. For example, the metal housing 115 can be made of stainless steel, which can be nickel plated if desired to limit corrosion. Also, the housing can be made of polymeric materials or other non-metal materials if desired within the scope of the invention. The housing 115 includes a raised central portion 117 and longitudinally extending sides 119 extending down from the central portion on opposite sides of the central portion. Bent under rims 121 are formed along the sides 119 of the housing 115 to form a pair of opposed channels 123 on opposite sides of the housing extending along the length of the housing. The housing 115 suitably has one or more longitudinally-extending ribs 125 along the central portion 117 of the housing. For example, the housing 115 in the illustrated embodiment has a pair of ribs 125, one of which extends along each side of the central portion 117 along substantially the entire length of the housing 115. Additional shorter longitudinally extending rib segments 127 are suitably formed in the housing 115 adjacent the rings 105 that are adjacent the ends of the housing 115 and at a location spaced laterally outward from the full-length ribs 125.

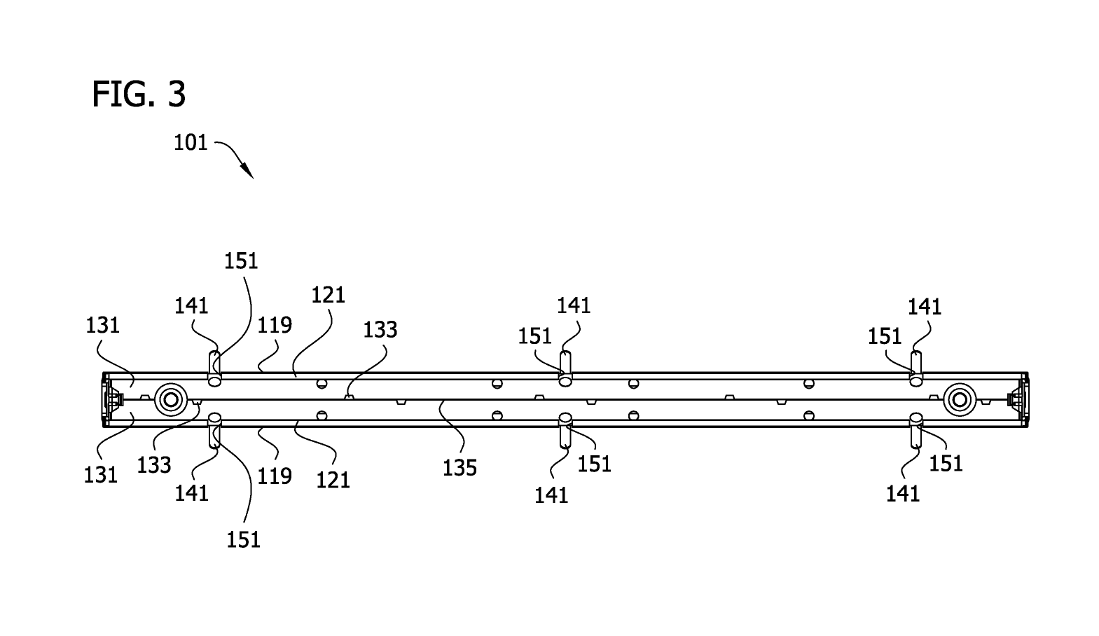

A pair of hinge plates 131 (FIGS. 3-6) are supported by the housing 115 for pivoting movement relative to the housing. In particular, a pair of elongate generally flat, stiff hinge plates 131 (e.g., made of stainless steel that is thicker than the sheet metal used to make the housing 115) are positioned side-by-side in the housing between the sides 119 and under the central portion 117 so the outer edges of the hinge plates are received in the channels 123 formed by the bent under rims 121 extending along the sides of the housing. The combined width of the hinge plates 131 exceeds the distance between the channels 123 formed in the sides 119 of the housing by the bent under rims 121 when the housing is in a relaxed un-deformed configuration. The hinge plates 131 have tabs 133 (FIGS. 3 and 4) along their inner edges which retain the hinge plates in side-by-side relation as they pivot relative to one another along a hinge line 135 where the inner edges of the hinge plates meet.

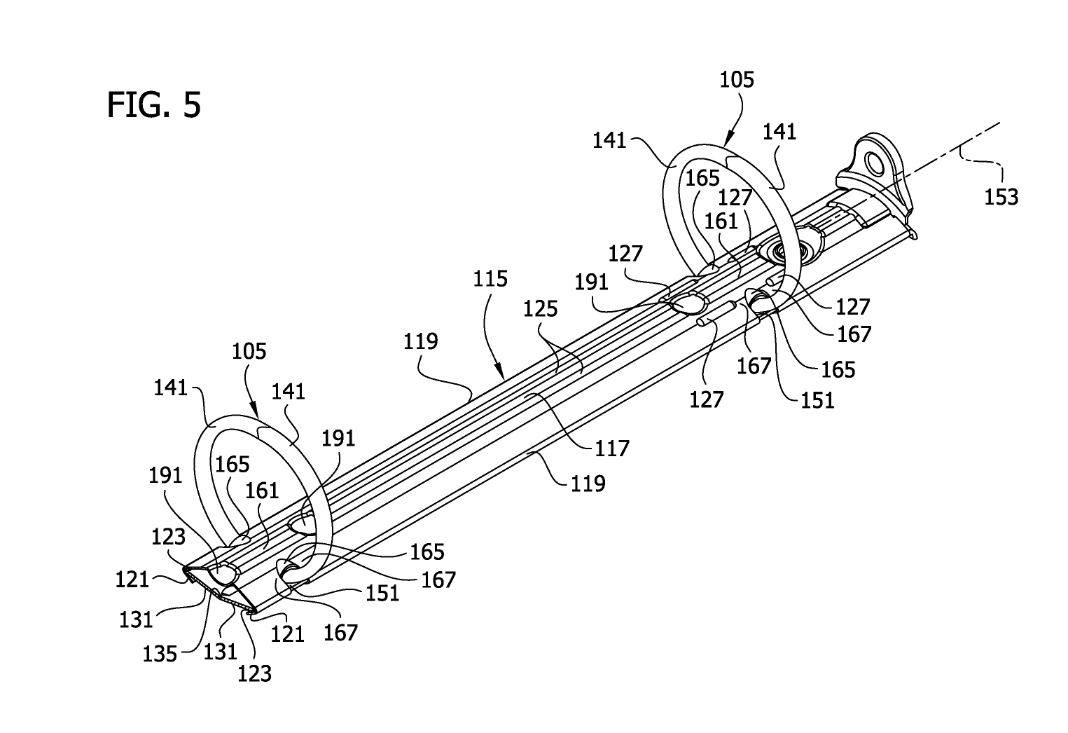

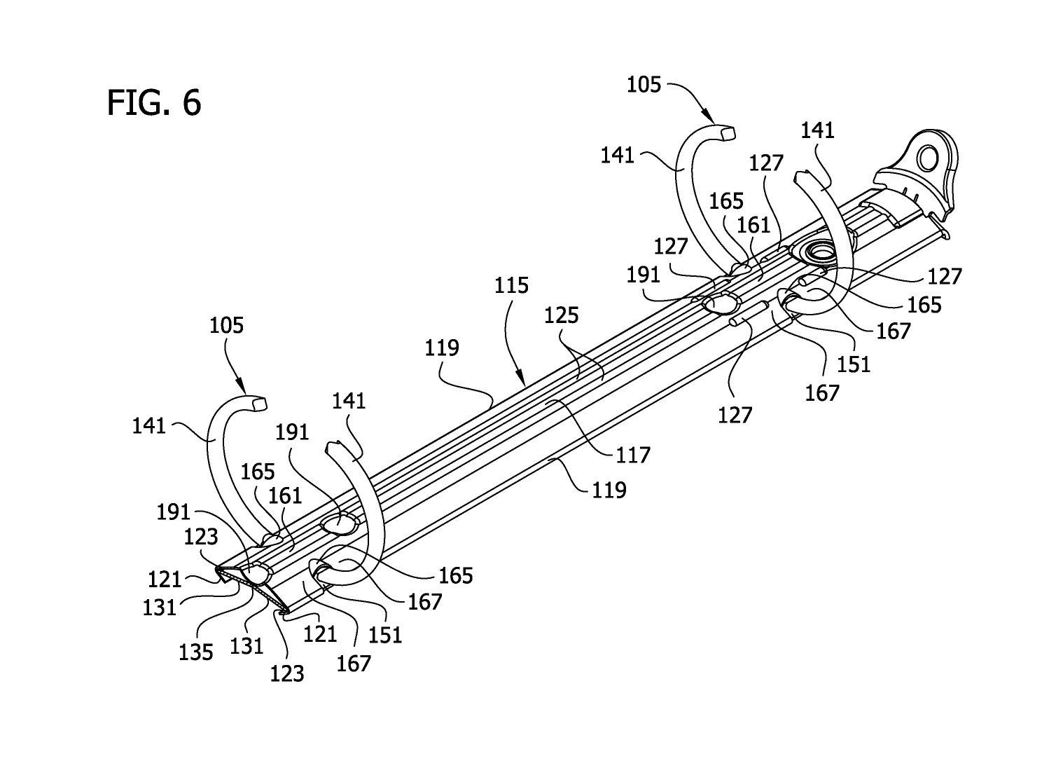

The mechanism 101 also includes a plurality of rings 105 for holding the loose-leaf pages. Each ring 105 includes a pair of ring members 141. At least one of the ring members 141 for each ring 105 is mounted on one of the hinge plates 131 and is moveable with the pivoting motion of the hinge plate relative to its corresponding ring member between a closed position (FIG. 5) and an open position (FIG. 6). In the closed position, the ring members 141 of each ring 105 form a substantially continuous closed loop for retaining loose-leaf pages. In the open position, the ring members 141 form a discontinuous open loop for adding and/or removing loose-leaf pages from the mechanism 101. In the illustrated embodiment, both ring members 141 in each pair are mounted on a corresponding one of the hinge plates 131. As the hinge plates 131 and ring members 141 pivot between the open and closed positions, the hinge plates pass through a co-planar orientation with one another at which point the hinge plates have deformed the housing 115 to spread the sides 119 of the housing far enough apart to accommodate the combined width of the hinge plates. This toggling action results in the housing 115 applying a spring biasing force tending to hold the rings 105 in the closed position when the rings are closed and tending to hold the rings in the open position when the rings are in the open position.

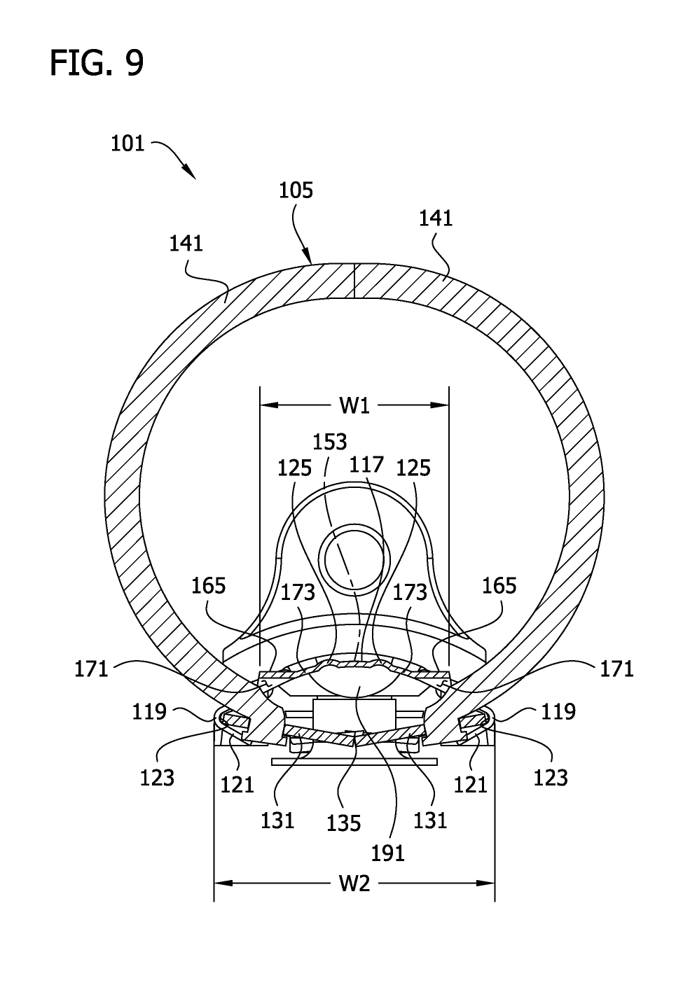

The housing 115 has openings 151 in its sides 119 for receiving the ring members 141. The openings 151 extend laterally inward toward the longitudinal centerline 153 of the elongate housing 115. The openings 151 are suitably notches that extend laterally inward from the sides 119 of the housing, as illustrated in FIGS. 4, 7, and 8. Because the notches 151 extend all the way to the sides 119 of the housing 115, it is possible during assembly of the ring mechanism 101 to insert the ring members 141 into the notches transversely from alongside of the housing (e.g., using an automated machine) without requiring the end of the ring member to be inserted through the opening. The longitudinally-aligned openings 151 for each ring 105 create a relatively narrow neck 161 in the housing 115 where the width W1 (FIG. 9) of the housing is significantly less than the overall width W2 of the housing between the sides 119. When the openings 151 are notches, as in the illustrated embodiment, the relatively narrow neck portion 161 of the housing 115 provides the only resistance to accidental bending of the housing at the neck.

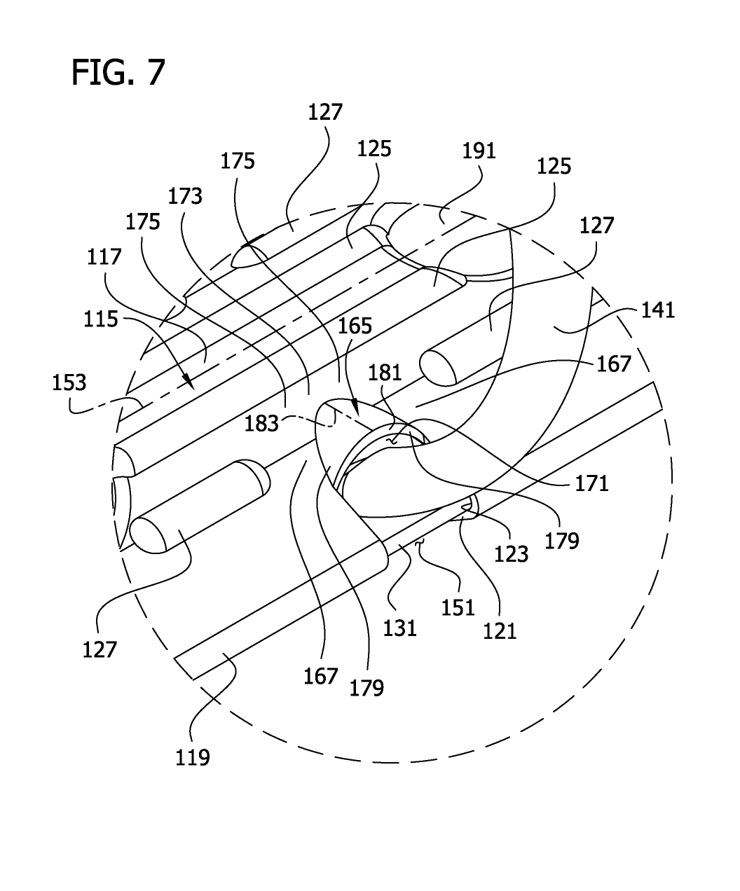

The openings 151 do not extend as far inward toward the longitudinal centerline 153 of the housing 115 as the openings do in some conventional ring mechanisms. The housing 115 suitably has a vault-forming portion 165 (FIGS. 7-9) at the inner margin of at least one of the openings 151. As illustrated in FIG. 4, there is a substantially identical vault-forming housing portion 165 at the inner margin of each opening 151 in the housing for the ring members 141, but this is not required within the broad scope of the invention. If desired, some of the advantages of the invention can be attained by including vault-forming housing portions at less than all of the openings for the ring members, including without limitation all of the openings on only one side of the housing, only a pair of openings on opposite sides of the housing for the ring members of a just one or more but less than all of the rings, or even just a single one of the openings.

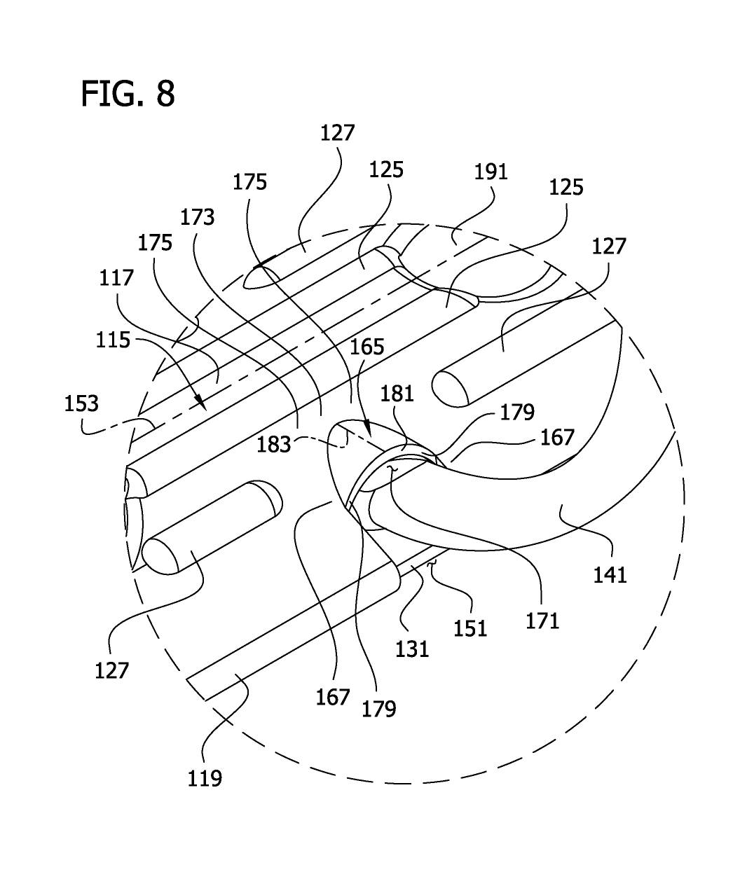

The vault-forming portion 165 of the housing 115 is suitably spaced from the longitudinal centerline 153 of the housing so the inner margin of the opening is offset from the longitudinal centerline. For example, as illustrated in FIGS. 7 and 8, one of the full-length longitudinally extending ribs 125 is positioned between each vault-forming portion 165 of the housing and the longitudinal centerline 153 of the housing. The vault-forming portion 165 is raised above longitudinally adjacent portions 167 of the housing spaced the same distance from the centerline 153. The vault-forming portion 165 is also spaced from the centerline 153 of the housing 115 by a non-vault forming portion 173 of the housing that is axially aligned with the opening 151 for the adjacent ring member 141 and that is not raised above axially adjacent portions 175 of the housing spaced the same distance from the centerline as the non-vault forming portion 173.

The vault-forming portion 165 of the housing 115 forms a vault 171 in the lower surface of the housing at the inner margin of the opening 151. The vault 171 is a space in the ceiling formed by the underside of the housing 115 that extends above the underside of the housing at locations longitudinally adjacent the vault and spaced the same distance laterally from the longitudinal centerline 153 of the housing as the vault. The vault 171 is sized and shaped to receive at least a portion of segment of the ring member 141 associated with the corresponding opening 151. The vault 171 extends laterally inward from the inner margin of the opening 151 For example, when the rings are closed as illustrated in FIG. 7, a portion of the segment of the ring member 141 adjacent the opening 151 is received in the vault 171. The vault-forming portion 165 of the housing 115 provides additional clearance for the ring members 141, especially in the closed position. For example, the vault 171 formed under the vault-forming portion 165 of the housing 115 allows the ring members 141 to pivot to the closed position notwithstanding a relatively low-profile of the housing and/or without requiring an unduly narrow neck 161 in the central portion 117 of the housing.

For example, the width W1 (FIG. 9) of the neck 161 is suitably at least about 40 percent of the width W2 of the housing, more suitably at least about 50 percent of the width W2 of the housing, and still more suitably at least about 65 percent of the width W2 of the housing. Thus, the vault-forming portion 165 of the housing 115 can facilitate use of a lower profile housing without restricting the range of motion of the ring members 141 and can facilitate making the housing from a thinner piece of sheet metal or other material because the extra width at the neck 161 created by vault-forming portion(s) 165 of the housing augments the housing's resistance to bending at the neck between the openings 151. Also, referring to FIG. 9, the vault forming portion 165 is disposed at an angle relative to the non-vault forming portion 173 of the housing at the inner margin of the vault forming portion and this can also increase resistance of the housing to bending at the neck 161 by increasing the bending moment of inertia of the housing 115 at the neck.

The vault-forming portion 165 of the housing is suitably a relatively small structure that does not extend very far from the opening 151. The vault-forming portion 165 suitably does not extend above the central portion 117 of the housing 115. For example, the vault-forming portion 165 of the housing 115 suitably extends no farther than about the diameter of the cross-sectional shape of the ring members 141 from the margins of the adjacent opening 151. Accordingly, the vault-forming portion 165 of the housing 115 does not increase overall height of the housing. The vault-forming portion 165 also adds little or nothing to the amount of material needed to make the housing 115.

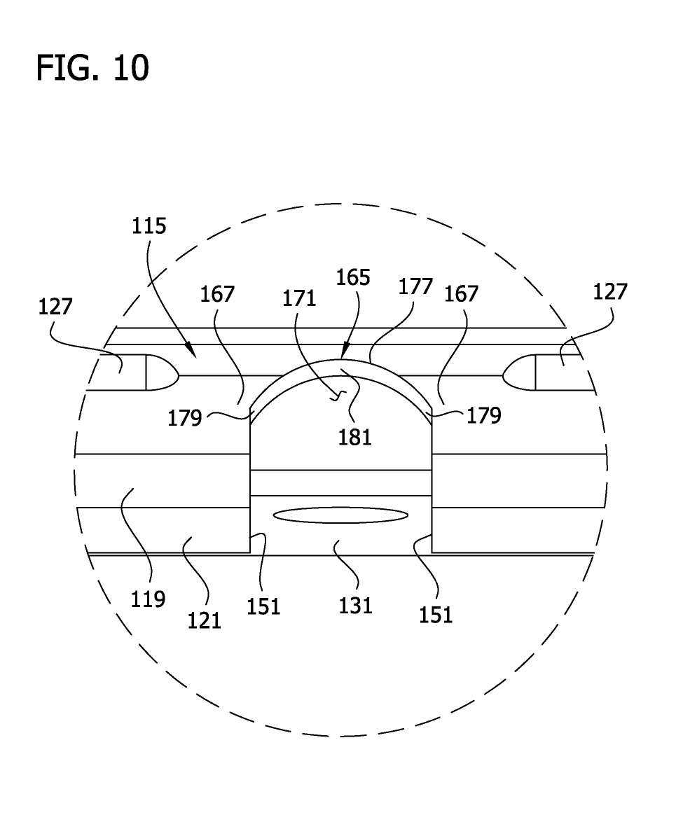

The vault-forming housing portion 165 can have various shapes or configurations within the scope of the invention. As illustrated in FIGS. 7-10, for example, the vault-forming portion 165 of the housing has an upper surface 177 (FIG. 10) having a convex curvature in the longitudinal direction of the housing 115. In this embodiment the vault-forming portion 165 of the housing 115 comprises an arch formed at the inner margin of the corresponding opening 151. The arch has feet 179 at its opposite ends at opposite sides of the opening 151 and on opposite sides of the adjacent ring member 141. The vault-forming arch 165 has an apex 181 that is aligned axially on the housing 115 with the adjacent ring member 141. Moreover, the vault-forming arch 165 extends laterally of the housing 115 and has crest 183 extending transversely inward of the elongate housing 115 from the apex 181 of the outer end of the arch 165 to the non-vault forming portion 173 of the housing (FIGS. 7-8). The vault 171 formed by the vault-forming portion 165 of the housing 115 suitably forms a short tunnel extending from the inner margin of the opening 151 toward the centerline 153 of the housing 115. As illustrated in FIG. 9, which is a cross section taken in a plane including a line extending along the crest 183, the highest point of the crest is suitably at the outer end of the vault forming arch 165. Moreover, the crest 183 can also be level or inclined downward toward the outer end of the vault-forming portion 165 within the scope of the invention, or have other configurations within the scope of the invention.

A suitable arch-shaped or other vault-forming housing portion 165 can be made by forming an upturned arch-shaped lip on the housing 115 at the inner margin of the opening 151. As used herein the phrase “upturned” does not require the feature to actually extend upward. Instead, a feature such as the lip 165 is also considered “upturned” when it is curved so it does not slope downwardly as rapidly as adjacent portions 167 of the housing 115. Moreover, the phrase “upturned” is intended to describe the end shape of the feature and does not require any particular method of manufacture. Referring again to FIGS. 7 and 8, the vault-forming portion 165 of the housing 115 can also be recognized in this embodiment as a feature that results in a raised bump at the inner margin of the opening 151. The bump 165 is configured to extend over the segment the corresponding ring member 141 when the rings are in the closed position.

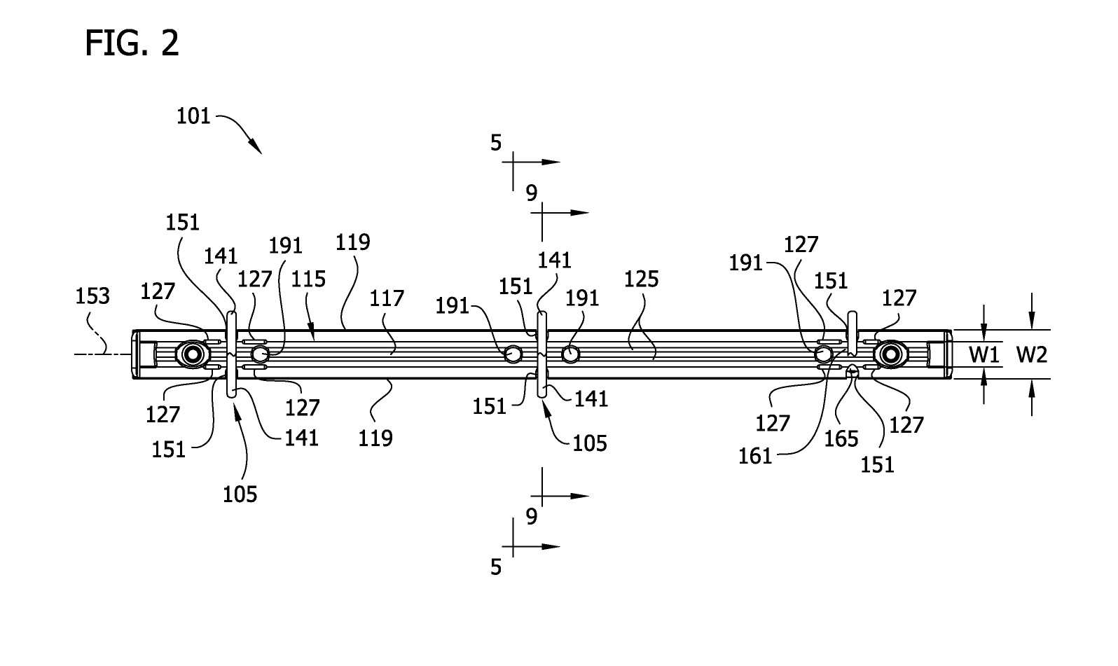

The housing 115 also has at least one dimple 191 positioned along the longitudinal centerline 153 of the housing in the central portion 117 of the housing. For example, the illustrated embodiment includes four such dimples 191 as may be seen in FIG. 2. Those skilled in the art will recognize the purpose of these dimples 191 is to form a sturdy dome-shaped structure that extends downward from the central portion 117 of the housing 115 toward the hinge plates 131. Analogous dimples are provided in axial alignment with the rings of at least some prior art ring mechanisms. The dimples 191 protect the housing 115 from being damaged by the stiff hinge plates 131 as the rings 105 move into the open position by providing a relatively sturdy dome-shaped engagement surface on the underside of the housing to absorb the impact of the hinge plates as they snap into the open position under the influence of the spring force from the housing. As illustrated in FIGS. 2 and 4, each of the dimples 191 is suitably spaced longitudinally of the housing from the necks 161 and the openings 151 in the housing 115 associated with the necks. Accordingly, each dimple 191 is offset longitudinally of the housing 115 from the ring members 141. None of the dimples 191 is aligned axially on the housing 115 with any of the necks 161, openings 151, or ring members 141. Accordingly, the transverse cross sections of the housing taken in a plane including a line axially aligned with the rings (e.g. FIG. 9) does not section any portion of any of the dimples 191. Further, each of the necks 161 is substantially free of dimples 191 that are impacted by the hinge plates 131 when the rings 105 open. This protects the housing 115 from being impacted by the hinge plates 131 at the relatively thin necks 161 and causes the impact forces from the hinge plates to be absorbed by a more robust portion of the housing 115 away from the necks.

The additional resistance to bending of the housing 115 resulting from the vault-forming housing portions(s) 165 is particularly advantageous during manufacture and assembly of the ring mechanism 101 because the housing is most vulnerable to accidental bending before the hinge plates 131 are assembled in the housing. Accordingly, the vault-forming portions 165 can decrease the precautions that are needed during manufacture and assembly of the ring mechanism 101 to protect the housing 115 from damage. The vault-forming portions can also reduce yield loss associated with damage accidentally inflicted on the housings 115 during manufacture. After the housing 115 is combined with the hinge plates 131, the relatively stiff hinge plates provide substantial reinforcement that greatly reduces the vulnerability of the housing to accidental bending or other damage. Nevertheless, the ring mechanism 101 still benefits from the additional strength in the housing 115 after assembly is complete.

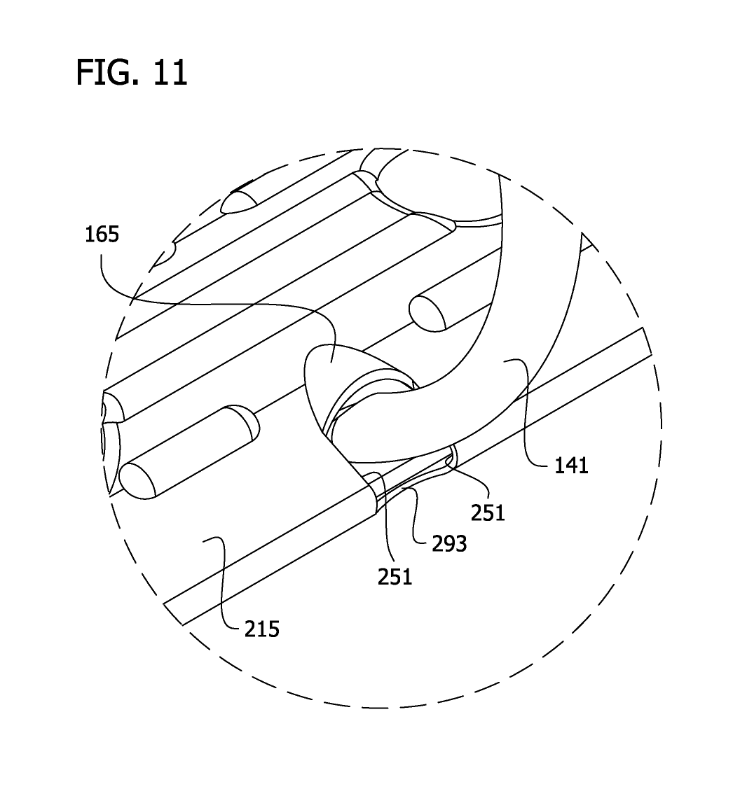

FIG. 11 illustrates a second embodiment of a ring mechanism. This mechanism is identical to the ring mechanism 101 described above except that for at least one of the ring member openings 251 (e.g., all of the ring member openings, the ring member openings along one side, or only a single ring member opening) of the housing 215 includes a strip 293 of material extending around the opposite side of the ring member 141 so the housing extends completely around the ring member. The strip 293 is suitably produced by forming the opening 251 from an opening near the side edge of a sheet metal blank used to make the housing that is spaced the width of the strip inward from the edge of the blank by the width of the strip. Accordingly, when the sheet metal blank is stamped or otherwise formed into the housing, portion of the blank between the opening and the side edge of the blank becomes the strip 293 of material at the side 119 of the housing (e.g., as part of the bent under rim 121). The housing 215 includes one or more vault-forming portions 165 as described above. The additional strip 293 of material makes the housing more resistant to bending than the housing would be without this strip of material. During assembly, the ring member 141 is inserted end first through the opening (e.g., manually or using machines that do not rely on the ability to insert the ring member into the opening through the open side of a notch). In all other respects, the mechanism operates as described for the mechanism 101 above.

When introducing elements of the present invention of the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the foregoing, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A ring mechanism for holding loose-leaf pages, the mechanism comprising:
an elongate housing having a central portion and longitudinally extending sides on opposite sides of the central portion;
first and second hinge plates supported by the housing for pivoting movement relative to the housing; and
rings for holding the loose-leaf pages, each ring including a first ring member and a second ring member, the first ring member being mounted on the first hinge plate and moveable with the pivoting motion of the first hinge plate relative to the second ring member between a closed position and an open position, the first and second ring members forming a substantially continuous closed loop in the closed position, the first and second ring members forming a discontinuous open loop in the open position,
wherein the housing has an opening for receiving one of the first ring members, the opening extending laterally inward toward a longitudinal centerline of the elongate housing, the housing having a vault-forming portion at the inner margin of the opening, the vault-forming portion of the housing being spaced from a longitudinal centerline of the housing and raised above longitudinally adjacent portions of the housing spaced the same distance from the centerline.

2. A ring mechanism as set forth in claim 1 wherein the vault-forming portion of the housing has an upper surface having a convex curvature in the longitudinal direction of the housing.

3. A ring mechanism as set forth in claim 1 wherein the vault-forming portion of the housing comprises an arch.

4. A ring mechanism as set forth in claim 3 wherein the arch has feet at its opposite ends and the feet are positioned axially on the housing on opposite sides of said one of the first ring members.

5. A ring mechanism as set forth in claim 3 wherein the arch has an apex positioned axially on the housing in alignment with said one of the first ring members.

6. A ring mechanism as set forth in claim 3 wherein the arch has a crest extending transversely of the elongate housing.

7. A ring mechanism as set forth in claim 3 wherein the arch forms a tunnel extending into the housing from the inner margin of the opening toward the centerline of the housing.

8. A ring mechanism as set forth in claim 1 wherein the vault-forming portion of the housing is sized and shaped to receive a segment of said one of the first ring members.

9. A ring mechanism as set forth in claim 8 wherein at least a portion of a segment of said one of the first ring members is received in a vault formed by the vault-forming portion of the housing when the rings are in the closed position.

10. A ring mechanism as set forth in claim 1 wherein the elongate housing is formed from a sheet of metal.

11. A ring mechanism as set forth in claim 10 wherein the housing comprises a longitudinally extending rib in the central portion of the housing.

12. A ring mechanism as set forth in claim 1 wherein the opening is a notch extending laterally inward from a side of the housing.

13. A ring mechanism as set forth in claim 1 wherein the opening is a first opening and the vault-forming portion of the housing is a first vault-forming portion, the housing having multiple additional openings for others of the ring members and multiple additional vault-forming portions at the inner margins of said additional openings, said additional vault-forming portions being configured so at least a portion of the vault-forming portions of the housing is spaced from a longitudinal centerline of the housing and raised above respective longitudinally adjacent portions of the housing spaced the same distance from the centerline.

14. A ring mechanism as set forth in claim 1 in combination with a cover, the ring mechanism being mounted on the cover, the cover being adapted to selectively cover or expose any loose-leaf pages retained on the rings.

15. A ring mechanism for holding loose-leaf pages, the mechanism comprising:
an elongate housing having a central portion and longitudinally extending sides on opposite sides of the central portion;
first and second hinge plates supported by the housing for pivoting movement relative to the housing; and
rings for holding the loose-leaf pages, each ring including a first ring member and a second ring member, the first ring member being mounted on the first hinge plate and moveable with the pivoting motion of the first hinge plate relative to the second ring member between a closed position and an open position, the first and second ring members forming a substantially continuous closed loop in the closed position, the first and second ring members forming a discontinuous open loop in the open position,
wherein the housing has an opening for receiving one of the first ring members, the opening extending laterally toward a longitudinal centerline of the elongate housing, the housing having an upturned lip at the inner margin of the opening.

16. A ring mechanism as set forth in claim 15 wherein the upturned lip forms an arch.

17. A ring mechanism as set forth in claim 16 wherein said arch has feet at its opposite ends, the feet being positioned axially on the housing on opposite sides of said one of the first ring members.

18. A ring mechanism as set forth in claim 16 wherein the arch has a crest extending transversely of the elongate housing and aligned axially on the housing with said one of the first ring members.

19. A ring mechanism as set forth in claim 15 wherein said opening is a notch extending laterally inward from one of the sides.

20. A ring mechanism for holding loose-leaf pages, the mechanism comprising:
an elongate housing having a central portion and longitudinally extending sides on opposite sides of the central portion;
first and second hinge plates supported by the housing for pivoting movement relative to the housing; and
rings for holding the loose-leaf pages, each ring including a first ring member and a second ring member, the first ring member being mounted on the first hinge plate and moveable with the pivoting motion of the first hinge plate relative to the second ring member between a closed position and an open position, the first and second ring members forming a substantially continuous closed loop in the closed position, the first and second ring members forming a discontinuous open loop in the open position,
wherein the housing has an opening for receiving one of the first ring members, the opening extending laterally toward a longitudinal centerline of the elongate housing, the housing having a raised bump at the inner margin of the housing, the bump being configured to extend over a segment of said one of the first ring members when the rings are in the closed position, the housing further comprising a dimple positioned along the longitudinal centerline of the housing and extending downward toward the hinge plates to protect the housing from being damaged by the hinge plates as the rings move into the open position, the dimple being offset axially on the housing the ring members.

21. A ring mechanism as set forth in claim 20 wherein the housing is free of any dimples positioned along the longitudinal centerline of the housing and extending downward toward the hinge plates at the location on the centerline of the housing longitudinally aligned with said one of the first ring members.

22. A ring mechanism as set forth in claim 20 wherein the opening is a notch extending laterally inward from one of the sides of the housing.
